(19) United States
(12) Patent Application Publication
(10) Pub. No.: US 2016/0086111 A1
(43) Pub. Date: Mar. 24, 2016

(54) ASSESSING PROJECT RISKS

(71) Applicant: International Business Machines Corporation, Armonk, NY (US)

(72) Inventors: Jose G. Cano Zapata, Mercedes Norte (CR); Sechan Oh, Jersey City, NJ (US); Alan Piciacchio, Wappingers Falls, NY (US)

(21) Appl. No.: 14/493,788

(22) Filed: Sep. 23, 2014

(51) Int. Cl. G06Q 10/06

(52) U.S. Cl. CPC G06Q 10/0635; G06Q 10/0633; G06Q 10/067

(57) ABSTRACT

One or more computer processors generate a probability model for a cycle time of a complexity category of a completed project. One or more computer processors determine an overdue risk probability of an active project using the generated probability model. The completed project has a start date and an end date. In addition, the cycle time reflects the time difference between the start date and the end date.

### BACKGROUND

The present disclosure relates generally to the field of project management, and more particularly to project risk management.

A project may be defined as a temporary group activity designed to produce a product, service, or result. Projects are temporary in that they have a defined beginning and end in time, and therefore, a defined scope and set of resources. Some projects may also be unique in that they are not routine operations but a specific set of operations designed to accomplish a particular goal. Some examples of projects include: the development of software for an improved business process, the construction of a building or bridge, the relief effort after a natural disaster, and the expansion of sales into a new geographic market.

Project management may be defined as the application of knowledge, skills, and techniques to complete projects effectively and efficiently. Project risk is an important aspect of project management. Project risk is generally defined as an unforeseen event or activity that can impact a project's progress, result, or outcome in a positive or negative way. A risk may be assessed in relation to its impact and probability of occurrence. Project risk (risk) assessment is an important aspect of project management. Risk is generally defined as an unforeseen event or activity that can impact a project's progress, result, or outcome in a positive or negative way. A risk may be assessed in relation to its impact and probability of occurrence. Subsequent to the assessment, risks may be prioritized. For example, a typical risk management prioritization might separate risks into categories, such as which risks should be eliminated, for example, because of extreme impact, which risks should have regular management attention and which risks are sufficiently minor to avoid detailed management attention.

The goodness of fit of a probability model is a known way to describe how well the probability model fits a set of observations. Measures of goodness of fit typically summarize the discrepancy between: (i) observed values; and (ii) the values expected under the probability model. Some ways in which goodness of fit measures have conventionally been used include the following: (i) statistical hypothesis testing (for example, to test for normality of residuals); (ii) to test whether two samples are drawn from identical distributions (a test called the Kolmogorov-Smirnov test is sometimes conventionally used for this), or (iii) whether outcome frequencies follow a specified distribution (a test called Pearson's chi-squared test is sometimes conventionally used for this).

### SUMMARY

According to embodiments of the present invention, one or more computer processors generate a probability model for a cycle time of a complexity category of a completed project. One or more computer processors determine an overdue risk probability of an active project using the generated probability model. The completed project has a start date and an end date. In addition, the cycle time reflects the time difference between the start date and the end date.

### BRIEF DESCRIPTION OF THE SEVERAL VIEWS OF THE DRAWINGS

FIG. 1 is a block diagram illustrating an environment, in accordance with an embodiment of the present invention.

FIG. 2 is a flowchart depicting the operational steps of a program function, in accordance with an embodiment of the present invention.

FIG. 3 depicts a block diagram of components of the server executing the program function, in accordance with an embodiment of the present invention.

### DETAILED DESCRIPTION

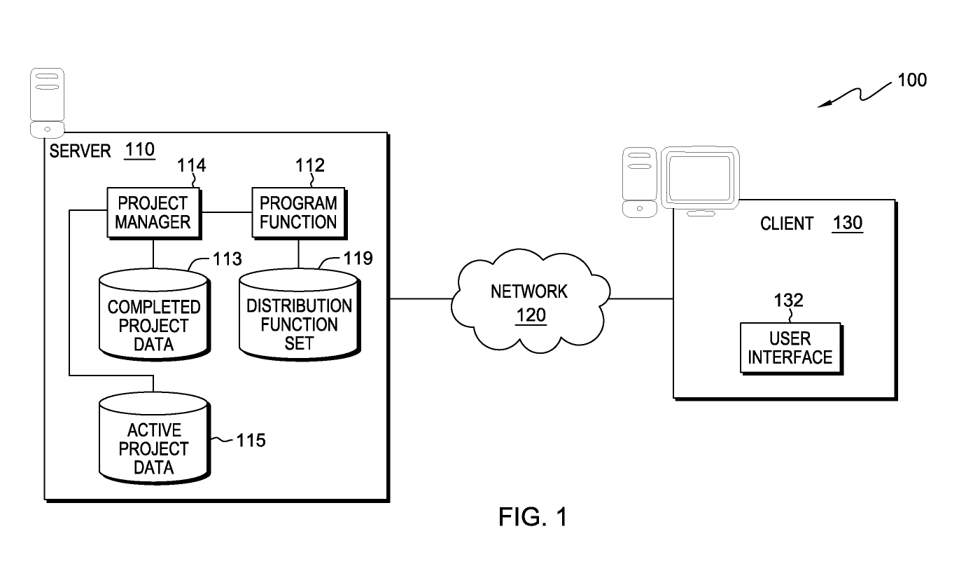

With reference now to FIGS. 1 to 3, the descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java™ Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention seek to assess risks, such as an overdue risk, without the use of scheduling information (that is any scheduling information beyond a start date and end date). A repository of completed projects is generated wherein each project is at least defined by a complexity category, start date, end date, and due date. Probability models are generated for the project cycle times for each complexity category. Risks are computed using the generated probability models.

A first, highly simplified embodiment of this disclosure (the “Simplified Embodiment”) will now be described without reference to the Figures in order to help the reader understand some of the concepts underlying some of the embodiments of the present invention. This embodiment, to be described over the course of the next few paragraphs, will be simplified to such an extent that it may not be directly suitable for many real world applications of the present inventions. Nevertheless, the concepts that will be explained in connection with this simplified embodiment may help the reader understand the more complex embodiment(s) that will be subsequently set forth in connection with the Figures.

In this Simplified Embodiment, the first step is generating, by one or more computer processors, a probability model for a cycle time of projects in a first complexity category. The first complexity category corresponds to the complexity of projects in the first complexity category. More specifically, there is historic data corresponding to nine projects, called Project A through Project I. Projects A to C have complexities such that they fall within the first complexity category. Projects D to F have complexities such that they fall within a second complexity category. Projects G to I have complexities such that they fall within a third complexity category. For purposes of generating the probability model for the first complexity category, the historic data of Projects A, B and C are used, and the historic data related to the other projects is effectively discarded. In this Simplified Embodiment: (i) Project A took 15 days to complete; (ii) Project B took 20 days to complete; and (iii) Project C took 25 days to complete. In this Simplified Embodiment, and based on the historic data of the foregoing sentence, the probability model is that a project in the first complexity category will be the average (specifically, arithmetic mean) of the completion times of Projects A, B and C, which is 20 days. In this Simplified Embodiment, the probability model is generated such that a given project in the first complexity category will be considered to have: (i) a 100% probability of completion for proposed cycle times of 20 days or more; and (ii) a zero (0) % probability of completion for proposed cycle times of 19 days or less.

Before moving on to the next step of this Simplified Embodiment, it is noted that the probability model of the Simplified Embodiment is not very granular with respect to proposed cycle times because a given proposed cycle time is considered to have a probability of on-time completion of 100% or 0%—nothing in between. Also, this particular probability model considers only the completion times of projects in the applicable historical data set—it does not consider at all the distribution of the historic cycle times about the average. More complex example(s) of probability model(s), with mathematical consideration of both historic cycle time and historic cycle time distributions will be discussed in detail in connection with subsequent embodiments which will be discussed in connection with the Figures. Regardless of the granularity and/or mathematical sophistication (or lack thereof) of the probability model, the probability model will provide a way to calculate a probability that an incoming proposed project will be completed in a time period between a given start date and given end date.

The Simplified Embodiment proceeds to its next step which is receiving: (i) a first proposed project that is in the first complexity category, (ii) an associated proposed start date; and (iii) an associated proposed end date. In this Simplified Embodiment, the proposed incoming project (sometimes called an “active project”) is called Project J, and it has a proposed start date of January 1st and a proposed end date of January 30th.

The Simplified Embodiment proceeds to its next step which is calculating, by the one or more computer processors, a probability that the first proposed project will be completed between its associated proposed start date and associated proposed end date based upon the probability model for the first complexity category. In this Simplified Embodiment, the proposed cycle time is 30 days because that is the number of days between the proposed start date and proposed end date. In this example, the end date is included in the proposed cycle time. In other embodiments, the proposed start and end dates may not be so included depending upon the specific design of the system designer. In this Simplified Embodiment, the probability model for the first complexity category calculates a 100% probability of on-time completion because the proposed 30 day cycle time is greater than 20 days.

Another embodiment of the present invention will now be described in detail with reference to the Figures. FIG. 1 is a block diagram illustrating an environment, generally designated 100, in accordance with one embodiment of the present invention. Environment 100 includes client 130 and server 110, all interconnected over network 120. Network 120 can be, for example, a local area network (LAN), a wide area network (WAN) such as the Internet, or a combination of the two, and can include wired, wireless, or fiber optic connections. Network 120 may be a distributed computing environment utilizing clustered computers and components that act as a single pool of seamless resources, as is common in data centers and with cloud computing applications or “clouds”. In general, network 120 can be any combination of connections and protocols that will support communications between server 110 and client 130.

In various embodiments of the present invention, client 130 and server 110 may be a laptop computer, a tablet computer, a netbook computer, a personal computer (PC), a desktop computer, a personal digital assistant (PDA), a smart phone, or any programmable electronic device capable of communicating with another programmable electronic device via network 120. Client 130 is a computing device used to access services provided by server 110. Client 130 includes user interface 132, which allows users of client 130 to access and manipulate information using project manager 114 and/or program function 112. Server 110 includes project manager 114, program function 112, completed project data 113, active project data 115, and distribution function set 119. In an embodiment, completed project data 113, active project data 115, and/or distribution function set 119 are in communication with server 110 via network 120.

Completed project data 113 is an information repository that includes information reflective of the project's complexity, start date, end date, and due date. Active project data 115 is an information repository that includes information reflective of the active project's complexity, start date, and due date. In an embodiment, the complexity of a completed or active project is determined by a user. In an embodiment, the complexity scale is numbered one through four, wherein one and four are the highest and lowest complexity values, respectively. In other embodiments, the complexity scale includes “high”, “medium”, and “low” complexity categories.

Project manager 114 is in communication with completed project data 113, active project data 115, and program function 112, in accordance with an embodiment of the present invention. Project manager 114 is software that is utilized to plan, organize, and/or control one or more of resources, procedures, and protocols to achieve a specific goal. A project may be defined as a temporary endeavor designed to produce a unique product, service, or result with a defined beginning and end that are undertaken to meet unique goals and objectives, such as bringing about a beneficial change and adding value.

A project can be deemed to be successful when the project's goals and objectives are successfully achieved within the predetermined timeframe. Project manager 114 facilitates the project planning and/or scheduling. Project manager 114 can sequence project activities as well as assign dates and resources to the project activities using a project management methodology. Program manager 114 can track the progress of an active project. Project manager 114 can determine the cycle time of a completed project. Cycle time is the time difference between the end date and the start date.

Program function 112 is in communication with project manager 114 and distribution function set 119, in accordance with an embodiment of the present invention. Distribution function set 119 is an information repository that includes distribution function sets generated by program function 112 (discussed below). Distribution functions describe the probability that a variate, X, takes on a value less than or equal to a number, x. Hence, distribution functions describe how values are allocated across a population or sample space. Program function 112 can generate cycle-time estimators that estimate the probability distribution of cycle times.

Program function 112 can determine which cycle-time estimator has the highest goodness of fit measurement. Measures of goodness of fit typically summarize discrepancies between observed values and the values expected under the model in question. Program function 112 generates probability models. A probability model is a mathematical representation of a random phenomenon and may be defined by its sample space, events within the sample space, and probabilities associated with each event. Program function 112 determines risk measurements that assess the probability of overdue risks that are associated with active projects. Program function 112 determines risk measurements that assess the expected overdue time duration that is associated with the active projects (that is, how far beyond the actual due date the active project is expected to be overdue). Program function 112 determines the overdue risk of an active project.

As an example, projects are often completed without a detailed planned schedule. However, for each of these projects, there exists a due date, which is often independent of the time it takes to complete the project. For example, when a client firm asks a service provider to submit proposals for small service contracts, the client firm sets the due dates based on their business needs, as opposed to being based on the time required for proposal development. In order for the project manager to ensure that all projects are completed on time, they need to assess the risks of outstanding projects without detailed schedule information. An example of the information typically associated with a project is included in Table 1:

| Project | COM- | | | |
|---|---|---|---|---|
| ID | PLEXITY | START DATE | DUE DATE | END DATE |
| 1 | 4 | Jun. 1, 2013 | Jun. 20, 2013 | Jun. 25, 2013 |
| 2 | 1 | May 3, 2013 | May 20, 2013 | May 5, 2013 |
| 3 | 2 | May 29, 2013 | Jun. 3, 2013 | Jun. 3, 2013 |

When a new project starts, the end date is typically not known. The complexity value is a predetermined value that can be determined by the portfolio manager and is reflective of the project's difficulty. In certain embodiments, for each complexity value, program function 112 constructs a probability model that predicts the cycle time, for example, the difference between the end date and the start date, using historical cycle-time data that is included in completed project data 113. For each complexity category, program function 112 determines the recent cycle-time data. For example, program function 112 generates a distribution function from the set of parameterized distribution functions for discrete random variables including Normal, Geometric, Lognormal, Zeta, Pareto, and Poisson random variables.

Program function 112 constructs the maximum likelihood estimator of each distribution function. Program function 112 determines the best fitting distribution function based on a goodness-of-fit measure, such as Kolmogorov-Smirnov Z value. The goodness-of-fit of a statistical model describes how well the model fits a set of observations. Measures of goodness-of-fit typically summarize the discrepancy between observed values and the values expected under the model in question. Such measures can be used in statistical hypothesis testing, such as the Kolmogorov-Smirnov test, to test whether two samples are drawn from identical distributions.

In an embodiment, to fit the cycle-time data to a lognormal distribution, program function 112 accesses completed project data 113 and ascertains the cycle times for completed projects in the, for example, “Medium” complexity category. If there are N completed “Medium” projects, their associated cycle times can be denoted by x₁, x₂, . . . , x_{N}. For each n=1, 2, . . . , N, a variable called zₙ, which represents a logarithmic transformation of xₙ, is defined by equation [1] as follows:

logₑ(xₙ+1) [1]

Program function 112 computes μ, which is the mean of transformed cycle times z₁, z₂, z₃, . . . , z_{N} and σ, which is the standard deviation of transformed cycle times z₁, z₂, z₃, . . . , zₙ. Hence, the Log-normal random variable with parameters μ and σ denotes the maximum likelihood estimator of the “Medium” category. The cumulative probability distribution of the estimated Log-normal distribution is given in equation[2].

F_{L}(x)=φ((logₑ(x)−μ)/σ) [2]

wherein φ(·) is the cumulative distribution function of the standard normal distribution.

Program function 112 can also fit cycle time to a geometric distribution. For example, program function 112 accesses completed project data 113 and ascertains the cycle times for completed projects in a particular complexity category, for example, “Medium”. If there are N completed “Medium” projects, their cycle times can be denoted by x₁, x₂, . . . , x_{N}. Program function 112 computes m, which is the mean of x₁, x₂, . . . , x_{N}. Program function 112 also computes the success probability of Geometric distribution p, which is defined in equation [3].

1/(1+m) [3]

Hence, the Geometric random variable with the success probability p denotes the maximum likelihood estimator for the “medium” category. The cumulative distribution function of the estimated Geometric distribution is defined by equation [4].

F_{G}(x)=1−(1−P)^{x+1} [4]

Program function 112 can assess an estimator's goodness-of-fit, which describes how well a statistical model fits a set of observations. For example, if F_{E}(x) is the empirical cumulative distribution function (c.d.f.) of cycle times for the “medium” complexity category, then for given cycle times x₁, x₂, x₃, . . . , xₙ, F_{E}(x) may be defined by equation [5].

(Number of cycle times that are equal to or less than x)/N [5]

The c.d.f. of the estimated Log-normal distribution of parameters μ and σ may be defined by equation [6].

F_{L}(x)=φ((logₑ(x)−μ)/σ) [6]

The c.d.f. of the estimated Geometric distribution of parameter p may be defined by equation [7].

F_{G}(x)=1−(1−p)^{x+1} [7]

The Kolmogorov-Smirnov Z value of the estimated Log-normal distribution can be defined by equation [8].

Z_{G}=maxₓ|F_{E}(x)−F_{L}(x)| [8]

The Kolmogorov-Smirnov Z value of the estimated Geometric distribution can be defined by equation [9].

Z_{L}=maxₓ|F_{E}(x)−F_{G}(x)| [9]

In one embodiment, the Geometric distribution may be deemed to possess a closer fit to the data than the Log-normal distribution if Z_{G}<Z_{L}. In another embodiment, the Log-normal distribution may be deemed to possess a closer fit to the data than the Geometric distribution if Z_{G}>Z_{L}.

Program function 112 can measure the risk of active projects. For example, two risk measures may be based on the estimated distribution functions. For a given complexity category c, wherein c corresponds to, for example, the “Medium” complexity category, F(x) can be the cumulative distribution function of the best fitting model from the previous steps, such as F_{G}(x) of F_{L}(x) discussed above.

Probability p_{c}(x) can be defined by equation [10].

Prob(cycle-time=x|complexity=c)=F(x)−F(x−1) [10]

In another embodiment, probability Q_{c}(x) can be defined by equation [11].

Prob(cycle-time>x|complexity=c)=1−F(x) [11]

Hence, a conditional probability Q_{c}(x|y) can be defined by equation [12].

Prob(cycle-time>x|y periods passed since project start,complexity=c)=Q_{c}(x)/Q_{c}(y) [12]

Risk measure 1, R1(a), defines the probability that Project A will not meet its completion due date (probability of an overdue risk), which can be defined by equation [13].

Q_{c(a)}(t(a)|y(a)) [13]

Wherein t(a) is the difference between the due date and start date of Project A (i.e., time given); y(a) is the difference between the current date and the start date of Project A (i.e., time passed); and c(a) is the complexity of Project A.

Risk measure 2, R2(a), defines the difference between the expected end date and due date for active Project A (overdue time duration), which can be defined by equation [14].

E[end date|y]−due date=Σ_{z=y+1}^{∞}z*p_{c(a)}(z)/Q_{c(a)}(y(a))−t(a) [14]

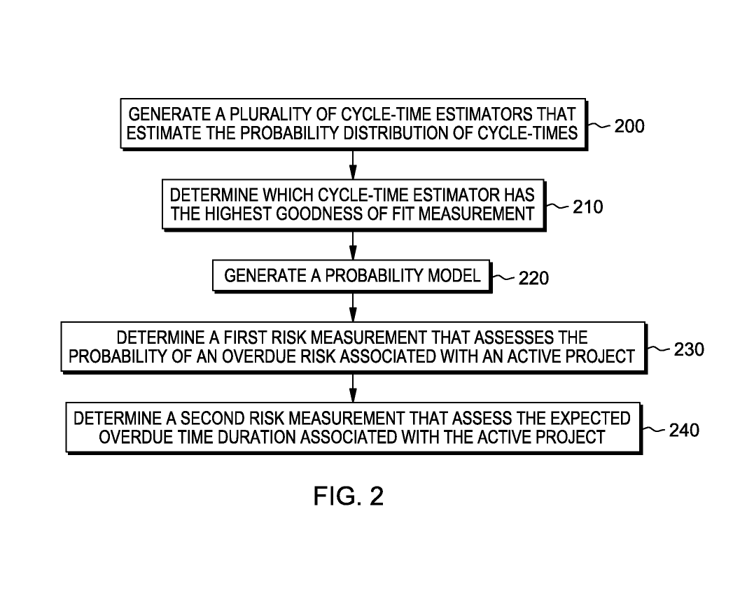

FIG. 2 is a flowchart depicting operational steps of program function 112, in accordance with an embodiment of the present invention. Program function 112 generates a plurality of cycle-time estimators that estimate the probability distribution of cycle times (step 200). Program function 112 determines which cycle-time estimator has the highest goodness of fit measurement (step 210). Program function 112 generates a probability model (step 220). Program function 112 determines a first risk measurement that assesses the probability of an overdue risk associated with an active project (step 230). Program function 112 determines a second risk measurement that assesses the expected overdue time duration associated with the active project (step 240).

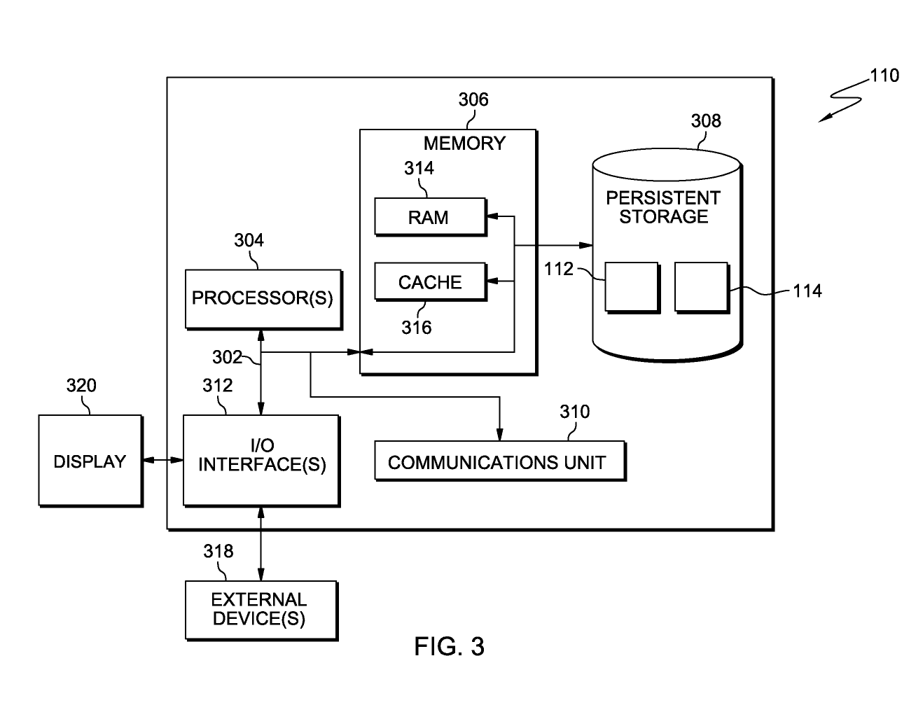

FIG. 3 depicts a block diagram of components of server 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

Project manager 114, program function 112, completed project data 113, distribution function set 119, and active project data 115 are stored in persistent storage 308 for execution and/or access by one or more of the respective computer processor(s) 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including client 130. In these examples, communications unit 310 includes one or more network interface cards. Communications unit 310 may provide communications through the use of either or both physical and wireless communications links. Project manager 114 and program function 112 may be downloaded to persistent storage 308 through communications unit 310.

I/O interface(s) 312 allows for input and output of data with other devices that may be connected to server 110. For example, I/O interface(s) 312 may provide a connection to external device(s) 318 such as a keyboard, a keypad, a touch screen, and/or some other suitable input device. External device(s) 318 can also include portable computer readable storage media such as, for example, thumb drives, portable optical or magnetic disks, and memory cards. Software and data used to practice embodiments of the present invention, e.g., program function 112 and project manager 114, can be stored on such portable computer readable storage media and can be loaded onto persistent storage 308 via I/O interface(s) 312. I/O interface(s) 312 also connects to a display 320. Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
generating, by one or more computer processors, a first probability model for generating predictive information regarding a completion period of projects in a first complexity category, with the first complexity category corresponding to the complexity of projects in the first complexity category;
receiving a first proposed project that is in the first complexity category, an associated proposed start date and an associated proposed end date; and
calculating, by the one or more computer processors, based upon the first probability model, a first probability that the first proposed project will be completed within a first proposed completion period.

2. The method of claim 1 wherein the operation of generating of the first probability model is based, at least in part, upon a first plurality of past completed projects, where the past completed projects were projects in the first complexity category and each past completed project is respectively associated with a completion period.

3. The method of claim 2 wherein the operation of generating the first probability model includes the following operations:
applying a plurality of distribution functions to the completion periods of the past completed projects of the first plurality of past completed projects; and
determining a first best fit distribution function from among the plurality of distribution functions based on a mathematical goodness of fit test, with the first best fit distribution being used as an operative distribution function for the first probability model.

4. The method of claim 3 wherein the mathematical goodness of fit test is the Kolmogorov-Smirnov test.

5. The method of claim 3 wherein the plurality of distribution functions include at least one of the following distribution functions: Normal, geometric, Lognormal, Zeta, Pareto and Poisson.

6. The method of claim 1 further comprising:
generating, by one or more computer processors, a second probability model for generating predictive information regarding a completion period of projects in a second complexity category, with the second complexity category corresponding to the complexity of projects in the second complexity category;
receiving a second proposed project that is in the second complexity category, an associated proposed start date and an associated proposed end date; and
calculating, by the one or more computer processors, based upon the second probability model, a first probability that the second proposed project will be completed within a second proposed completion period.

7. The method of claim 6 wherein:
the operation of generating of the first probability model is based, at least in part, upon a first plurality of past completed projects, where the past completed projects were projects in the first complexity category and each past completed project is respectively associated with a completion period;
the operation of generating of the second probability model is based, at least in part, upon a second plurality of past completed projects, where the past completed projects were projects in the second complexity category and each past completed project is respectively associated with a completion period;
the operation of generating the first probability model includes the following operations:
applying a plurality of distribution functions to the completion periods of the past completed projects of the first plurality of past completed projects, and
determining a first best fit distribution function, for the first complexity category, from among the plurality of distribution functions based on a mathematical goodness of fit test, with the first best fit distribution being used as an operative distribution function for the first probability model; and
the operation of generating the second probability model includes the following operations:
applying the plurality of distribution functions to the completion periods of the past completed projects of the second plurality of past completed projects, and
determining a second best fit distribution function, for the second complexity category, from among the plurality of distribution functions based on a mathematical goodness of fit test, with the second best fit distribution being used as an operative distribution function for the second probability model.

8. A computer program product comprising:
one or more computer readable tangible storage media and program instructions stored on the one or more computer readable tangible storage media, the program instructions executable by one or more processors to:
generate a first probability model for generating predictive information regarding a completion period of projects in a first complexity category, with the first complexity category corresponding to the complexity of projects in the first complexity category;
receive a first proposed project that is in the first complexity category, an associated proposed start date and an associated proposed end date; and
calculate, based upon the first probability model, a first probability that the first proposed project will be completed within a first proposed completion period.

9. The product of claim 8 wherein the first probability model is based, at least in part, upon a first plurality of past completed projects, where the past completed projects were projects in the first complexity category and each past completed project is respectively associated with a completion period.

10. The product of claim 9 wherein the program instructions to generate the first probability model include program instructions to:
apply a plurality of distribution functions to the completion periods of the past completed projects of the first plurality of past completed projects; and
determine a first best fit distribution function from among the plurality of distribution functions based on a mathematical goodness of fit test, with the first best fit distribution being used as an operative distribution function for the first probability model.

11. The product of claim 10 wherein the mathematical goodness of fit test is the Kolmogorov-Smirnov test.

12. The product of claim 10 wherein the plurality of distribution functions include at least one of the following distribution functions: Normal, geometric, Lognormal, Zeta, Pareto and Poisson.

13. The product of claim 8 wherein the program instructions are further executable by one or more processors to:
generate a second probability model for generating predictive information regarding a completion period of projects in a second complexity category, with the second complexity category corresponding to the complexity of projects in the second complexity category;
receive a second proposed project that is in the second complexity category, an associated proposed start date and an associated proposed end date; and
calculate, based upon the second probability model, a first probability that the second proposed project will be completed within a second proposed completion period.

14. The product of claim 13 wherein:
the program instructions to generate the first probability model are based, at least in part, upon a first plurality of past completed projects, where the past completed projects were projects in the first complexity category and each past completed project is respectively associated with a completion period;
the program instructions to generate the second probability model are based, at least in part, upon a second plurality of past completed projects, where the past completed projects were projects in the second complexity category and each past completed project is respectively associated with a completion period;
the program instructions to generate the first probability model include program instructions executable to:
apply a plurality of distribution functions to the completion periods of the past completed projects of the first plurality of past completed projects, and
determine a first best fit distribution function, for the first complexity category, from among the plurality of distribution functions based on a mathematical goodness of fit test, with the first best fit distribution being used as an operative distribution function for the first probability model; and
the program instructions to generate the second probability model include program instructions executable to:
apply the plurality of distribution functions to the completion periods of the past completed projects of the second plurality of past completed projects, and
determine a second best fit distribution function, for the second complexity category, from among the plurality of distribution functions based on a mathematical goodness of fit test, with the second best fit distribution being used as an operative distribution function for the second probability model.

15. A computer system comprising:
one or more computer processors;
one or more computer readable tangible storage media;
program instructions stored on the one or more computer readable tangible storage media for execution by at least one of the one or more computer processors, the program instructions comprising program instructions to:
generate a first probability model for generating predictive information regarding a completion period of projects in a first complexity category, with the first complexity category corresponding to the complexity of projects in the first complexity category;
receive a first proposed project that is in the first complexity category, an associated proposed start date and an associated proposed end date; and
calculate, based upon the first probability model, a first probability that the first proposed project will be completed within a first proposed completion period.

16. The system of claim 15 wherein the first probability model is based, at least in part, upon a first plurality of past completed projects, where the past completed projects were projects in the first complexity category and each past completed project is respectively associated with a completion period.

17. The system of claim 16 wherein the program instructions to generate the first probability model include program instructions to:
apply a plurality of distribution functions to the completion periods of the past completed projects of the first plurality of past completed projects; and
determine a first best fit distribution function from among the plurality of distribution functions based on a mathematical goodness of fit test, with the first best fit distribution being used as an operative distribution function for the first probability model.

18. The system of claim 17 wherein the mathematical goodness of fit test is the Kolmogorov-Smirnov test.

19. The system of claim 17 wherein the plurality of distribution functions include at least one of the following distribution functions: Normal, geometric, Lognormal, Zeta, Pareto and Poisson.

20. The system of claim 15 wherein the program instructions are further executable by one or more processors to:
generate a second probability model for generating predictive information regarding a completion period of projects in a second complexity category, with the second complexity category corresponding to the complexity of projects in the second complexity category;
receive a second proposed project that is in the second complexity category, an associated proposed start date and an associated proposed end date; and
calculate, based upon the second probability model, a first probability that the second proposed project will be completed within a second proposed completion period.
